(19) United States
(12) Patent Application Publication
(10) Pub. No.: US 2016/0006243 A1
(43) Pub. Date: Jan. 7, 2016

(54) HUB

(71) Applicant: UNIVERSITY COURT OF THE UNIVERSITY OF ABERDEEN, Aberdeen, Aberdeenshire (GB)

(72) Inventors: Dragan Jovcic, Aberdeen (GB); Weixing Lin, Aberdeen (GB)

(21) Appl. No.: 14/768,171

(22) PCT Filed: Feb. 13, 2014
(86) PCT No.: PCT/GB2014/050416

§ 371 Date: Aug. 14, 2015

(30) Foreign Application Priority Data
Feb. 15, 2013 (GB) 1302671.1
Feb. 18, 2013 (GB) 1302797.4

(51) Int. Cl. H02J 1/10

(52) U.S. Cl. CPC H02J 1/102; H02J 2001/008

(57) ABSTRACT

A hub for transferring power between DC systems. The hub comprises N modules, each for connection to a respective DC system of voltage V_{idc} and for exchanging power P₁ with the respective DC system, and a common p-phase AC bus for connecting the N modules. Each module comprises a DC/AC converter for transforming the respective DC voltage V_{idc} into a respective p-phase AC voltage V_{iac} of frequency ωₛ.

The present invention relates to an electronic hub for transferring power between a plurality of DC systems.

DC (direct current) power transmission is significantly better than AC (alternating current) transmission when a single line at a single voltage level is considered. However, DC transmission is not widespread because of the difficulties in voltage stepping and fault isolation. There are many point-to-point HVDC (High Voltage Direct Current) links worldwide which are justified where performance benefits outweigh additional converter costs. In the offshore environment (cable systems), AC transmission has extremely poor performance that necessitates HVDC use. VSC (Voltage Source Converter) is a major improvement in HVDC technology, and has been use in the field for over 10 years at around 20 projects worldwide. VSC HVDC technology has already been implemented for connecting two offshore wind farms and two oil platforms in Europe.

The offshore environment is the primary driver for advancing HVDC to meshed DC grids. However, there are others. Worldwide, there are many HVDC lines operating solely as point-to-point links. There would be significant performance/operational and cost benefits if these lines could be interconnected or tapped on the DC side. Similar arguments apply for developing an EU-wide DC Supergrid and a North Sea offshore grid [1].

In the last 10 years, major advances have been made in high-power electronics. There is growing confidence that the current status of high power electronics will enable the development of converter systems that will lead to cost-effective DC transmission networks with similar reliability and better performance than AC grids. DC transmission grids have been extensively studied in the past 5 years and they are becoming accepted technology. Manufacturers are already offering 300 kV, 9 kA semiconductor DC CB (circuit breakers) [2] and they confidently tender for simple DC grids. Nevertheless, there are significant outstanding challenges with DC circuit breakers, which relate to costs and protection coordination over large distances. The cost of semiconductor DC CB is high, at the same order of magnitude as full VSC converters or DC/DC converters. Adopting specialised electronic DC circuit breakers implies that DC voltage stepping (DC/DC conversion) will be achieved by other electronic components, which results in a further cost penalty.

Existing AC grids were designed on the assumption that simple and inexpensive AC circuit breakers can be placed at the ends of each transmission line. Similarly, simple electro-mechanical transformers have facilitated ready voltage matching. Ring topologies and highly-meshed networks give a cost-effective solution when circuit breakers are inexpensive. However, DC networks cannot adopt such topologies because of high costs and losses associated with voltage stepping and fault isolation components.

High power DC/DC converters take the role of transformers in AC grids. Unlike AC transformers, DC converters are based on semiconductors and are thus highly controllable. This controllability makes other functions possible in addition to voltage stepping. Previous studies have shown that a DC/DC converter can take the role of a traditional transformer, circuit breaker and power regulator in a single component [3]. It would be desirable to have an electronic DC substation connecting multiple DC lines and independently managing all DC grid control operation and protection functions. The cost of such a DC substation would be high, but performance would be considerably better than an AC substation.

Variable speed machines such as wind generators have low voltage output and use multiple AC/DC conversion stages which can be optimized if DC grids are used. Some manufacturers offer MW class wind generators with DC output [4]. Medium voltage DC collection grids have advantages with large wind power parks and PV (photo-voltaic) arrays [5].

Reference [6] presents a DC/DC converter topology that could achieve very high voltage stepping ratio without intermediate AC transformers. The topology can operate at very high switching frequencies and can be built for high current and high voltage. However, the study primarily focuses on a two-port converter, i.e., interconnecting two DC systems. Numerous 2-port DC/DC converters would be required for a complex DC grid, which results in increased costs. For complex DC grids, it is more cost-effective to use multi-port DC/DC converters (hubs) in order to reduce the number of conversion stages and components.

Reference [6] also presents a multi-terminal DC/DC converter with the capability to transfer power between n DC systems of voltage V₁ and m DC systems of voltage V₂. However, this does not allow for the interconnection of DC systems with more than 2 different voltages. Moreover, the multi-terminal converter disclosed in reference [6] does not allow for flexible connection and disconnection of DC systems.

According to one aspect of the present invention, there is provided a p-phase electronic hub for transferring power between N DC systems of DC voltage V_{idc} (i=1, 2, . . . N), respectively, the hub comprising:—

N modules, each for connection to a respective DC system of voltage V_{idc} and for exchanging power Pᵢ with the respective DC system; and

a common p-phase AC bus for connecting the N modules;

wherein each module comprises:—

a DC/AC converter for transforming the respective DC voltage V_{idc} into a respective p-phase AC voltage v_{iac} of frequency ωₛ, root mean square line-neutral magnitude V_{iacm} and angle αᵢ; and

an LC circuit for each phase p, for transferring power between the DC/AC converter of the module and the p-phase AC bus, wherein each LC circuit comprises an inductor Lᵢ, a capacitor Cᵢ for supplying reactive power, and a circuit breaker CBᵢ for disconnecting the module, connected together at their first terminals, the second terminal of each inductor Lᵢ being connected to the respective phase of the respective AC voltage v_{iac}, the second terminal of the circuit breaker CBᵢ being connected to the respective phase of the common AC bus. Preferably, the second terminal of capacitor Cᵢ is connected to a central point of the respective DC voltage V_{iac} in the case where p=1. The second terminals of the capacitors Cᵢ associated with each phase p are preferably connected together in the case where p>1.

With this configuration, each module incorporates LC circuitry, and the modules are connected to one another by means of a common p-phase AC bus. Accordingly, it is straightforward to connect an additional DC system to the hub simply by connecting an additional module to the p-phase AC bus. Modification of the LC circuits of the modules already connected to the hub is not required. Similarly, it is straightforward to disconnect a DC system from the hub without modification of the remaining modules, by disconnecting a module from the p-phase AC bus.

In particular, the circuit breaker(s) CBᵢ located at the bus side of capacitors(s) Cᵢ, enable straightforward connection and disconnection of a module and its LC circuit(s) from the hub, such that the basic operating principles of the remaining modules are not affected.

This is in contrast to the DC/DC converter of reference [6], in which each terminal or module comprises a DC/AC converter, and these modules are connected by an inner LCL circuit for each phase. Thus, if a module were to be added or removed, the inner LCL circuit(s) would need to be redesigned in order for the converter to operate.

The hub of the present invention is for transferring power between N DC systems, where N is any positive integer greater than 1. Power may be injected into the hub or absorbed from the hub by each DC system, provided that the total power flowing into the hub is equal to the total power flowing out, which is achieved with appropriate control.

The AC voltages v_{iac} generated by the DC/AC converters each have p phases, where p is any positive integer greater than 0.

The hub comprises a common p-phase AC bus (which may also be referred to as p common AC buses, where p is the number of phases). The p-phase AC bus comprises one electrical pathway or bus for each phase. However, in some embodiments, the hub may comprise one or more additional pathways or busses. For example, in the case of a two phase hub, three pathways may be provided. One for each phase plus a neutral bus. In the case where p=1 (ie, the single phase topology) the return AC current path is preferably provided by connecting a common module point with the DC voltage central point.

Since the LC circuits of the hub operate with alternating current, commonly available mechanical circuit breakers for use with AC systems may be used as the circuit breakers _{Cbi}.

Preferably, in use, the voltage of capacitor(s) Cᵢ is regulated such that its fundamental root mean square line-neutral magnitude is V_{cm}, where V_{cm}>V_{iacm0} for all i, wherein V_{iacm0} is the maximum fundamental root mean square line-neutral magnitude of v_{iac}.

According to a second aspect of the present invention, there is provided a p-phase electronic hub for transferring power between N DC systems of DC voltage V_{idc} (i=1, 2, . . . N), respectively, the hub comprising:—

N modules, each for connection to a respective DC system of voltage V_{idc}, and for exchanging power Pᵢ with the respective DC system; and

a common p-phase AC bus for connecting the N modules; wherein each module comprises:—

a DC/AC converter for transforming the respective DC voltage V_{idc} into a respective p-phase AC voltage v_{iac} of frequency ωₛ, root mean square line-neutral magnitude V_{iacm} and angle αᵢ, such that

V̅_̅{̅i̅a̅c̅}̅=V_{iacm} cos(αᵢ)+jV_{iacm} sin(αᵢ)=V_{iacd}+jV_{iacq}

where V̅_̅{̅i̅a̅c̅}̅ is the phasor of v_{iac}; and

an LC circuit for each phase p, for transferring power between the DC/AC converter of the module and the common p-phase AC bus, wherein each LC circuit comprises an inductor Lᵢ, a capacitor Cᵢ for supplying reactive power and a circuit breaker CBᵢ for disconnecting the module, connected together at their first terminals, the second terminal of each inductor Lᵢ being connected to the respective phase of the respective AC voltage V_{iac}, the second terminal of the circuit breaker CBᵢ being connected to the respective phase of the common AC bus, the second terminal of capacitor Cᵢ being connected to a central point of respective DC voltage V_{idc} in the case where p=1, and the second terminals of capacitors Cᵢ associated with each phase p being connected together in the case where p>1;

wherein, in use, the voltage of capacitor(s) Cᵢ is regulated to have a root mean square line-neutral magnitude V_{cm}, where V_{cm}>V_{iacm} for all i;

wherein the value of each inductor Lᵢ is selected according to the formula:—

$${L}_{i} = \frac{{V}_{iacq} {V}_{cm}}{{P}_{im}}$$

and wherein the value of each capacitor Cᵢ is selected according to the formula:—

$${C}_{i} = \frac{{V}_{cm} - {V}_{iacd}}{{ω}_{s}^{2} {V}_{cm} {L}_{i}}$$

wherein V_{iacd} and V_{iacq} are any positive values that satisfy the inequality V_{iacd}²+V_{iacq}²≦V_{iacm0}², wherein V_{iacm0} is the maximum value of V_{iacm}.

In a preferred embodiment, the value of each inductor Lᵢ is selected according to the formula:—

$${L}_{i} = \frac{{V}_{iacm 0} \sqrt{{V}_{cm}^{2} - {V}_{iacm 0}^{2}}}{{P}_{im} {ω}_{s}}$$

and the value of each capacitor Cᵢ is selected according to the formula:—

$${C}_{i} = \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$

where V_{iacm0} is the maximum value of V_{iacm}.

These formulas for Lᵢ and Cᵢ are designed to achieve zero reactive power at module i, at maximum power transfer. This in turn minimises current magnitude and therefore minimises switching and conduction losses at full power.

Preferably, the power exchanged by each module with the respective DC system is controllable by varying V_{iacm} and αᵢ of the AC voltage v_{iac} generated by the DC/AC converter of the respective module.

Preferably, at least one of the N modules is configured for regulating the capacitor voltage v_{c} to have a fundamental root mean square line-neutral magnitude V_{cm}.

Preferably, the other(s) of said N modules is/are configured for regulating the power exchanged by that module with the respective DC system.

Where p>1, the second terminals of the capacitors Cᵢ associated with each AC/DC converter may be connected in ring between phases. In particular, where p=3, the second terminals of the capacitors Cᵢ associated with each AC/DC converter may be connected in delta between phases. Other capacitor connection can also supply reactive power in symmetrical and balanced manner.

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages v_{iac} of frequency ωₛ, root mean square line-neutral magnitude V_{iacm} and angle αᵢ;

a LC circuit for each phase for each AC/DC converter, wherein each LC circuit comprises an inductors Lᵢ, a capacitor Cᵢ for supplying reactive power and a circuit breaker CBi connected together at their first terminals, the second terminal of each inductor Lᵢ being connected to the respective phase of the respective AC voltage vᵢ, the second terminal of CBᵢ connected to a common hub AC bus for particular phase, wherein the second terminals of all capacitors are connected to respective AC bus and the second terminals of Cᵢ are connected to a common point (star point) or they can be connected in delta between other phases or if p=1 to central point of DC voltage,

wherein the value of the capacitor Cᵢ and each inductor Lᵢ are selected to enable required power transfer at respective DC system, at required DC voltage, to minimize reactive power exchange between AC/DC converters and to minimize hub losses.

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages V_{iac} of frequency ωₛ, root mean square line-neutral magnitude V_{iacm} and angle αᵢ, also expressed as

V̅_̅{̅i̅a̅c̅}̅=V_{iacm} cos(α_{i′})+jV_{iacm} sin(α_{i′})=V_{iacd}+jV_{iacq}

where V̅_̅{̅i̅a̅c̅}̅ is the phasor of v_{iac};
and exchanging power Pᵢ between i-th DC system the hub comprising:

a LC circuit for each phase for each AC/DC converter, wherein each LC circuit comprises an inductors Lᵢ, a capacitor Cᵢ for supplying reactive power and a circuit breaker CBᵢ connected together at their first terminals, the second terminal of each inductor Li being connected to the respective phase of the respective AC voltage V_{iac}, the second terminal of CBᵢ connected to a common hub AC bus for particular phase, wherein the second terminals of all capacitors are connected to a common point (star point) or they can be connected in delta between other phases, or if p=1 to central point of DC voltage,

wherein the voltage of capacitors is regulated at nominal value V_{cm}, V_{cm} being larger than V_{iacm0},

wherein the value of each inductor Lᵢ is selected according to the formula:

$${L}_{i} = \frac{{V}_{iacq} {V}_{cm}}{{P}_{im}}$$

the value of capacitor Cᵢ is selected according to the formula:

$${C}_{i} = \frac{{V}_{cm} - {V}_{iacd}}{{ω}_{s}^{2} {V}_{cm} {L}_{i}}$$

wherein V_{iacd} and V_{iacq} are any positive values that satisfy the inequality V_{iacd}²+V_{iacq}²≦V_{iacm0}², wherein V_{iacm0} is the maximum value of V_{iacm}.

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages v_{iac} of frequency ωₛ, fundamental root mean square line-neutral magnitude V_{iacm} and angle αᵢ, and exchanging power Pᵢ between i-th DC system the hub comprising:

a LC circuit for each phase for each AC/DC converter, wherein each LC circuit comprised an inductor Lᵢ, a capacitor Cᵢ for supplying reactive power and a circuit breaker CBᵢ connected together at their first terminals, the second terminal of each inductor Lᵢ being connected to the respective phase of the respective AC voltage v_{iac}, the second terminal of CBᵢ connected to a common hub AC bus for particular phase, wherein the second terminals of all capacitors are connected to a common point (star point) or they can be connected in delta between other phases or if p=1 to central point of DC voltage,

wherein the voltage of capacitors is regulated at nominal value V_{cm}, V_{cm} being larger than V_{iacm0},

wherein the value of each inductor Lᵢ is selected according to the formula:

$${L}_{i} \leq \frac{{V}_{iacm 0} \sqrt{{V}_{cm}^{2} - {V}_{iacm 0}^{2}}}{{P}_{im} {ω}_{s}}$$

the value of capacitor Cᵢ is selected according to the formula:

$${C}_{i} \geq \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages v_{iac} of frequency ωₛ, fundamental root mean square line-neutral magnitude V_{iacm} and angle αᵢ, and exchanging power Pᵢ between i-th DC system the hub comprising:

a LC circuit for each phase for each AC/DC converter, wherein each LC circuit comprises an inductors Lᵢ, a capacitor Cᵢ for supplying reactive power and a circuit breaker CBᵢ connected together at their first terminals, the second terminal of each inductor Lᵢ being connected to the respective phase of the respective AC voltage v_{iac}, the second terminal of CBᵢ connected to a common hub AC bus for particular phase, wherein the second terminals of all capacitors are connected to a common point (star point) or they can be connected in delta between other phases or if p=1 to central point of DC voltage,

wherein the voltage of capacitors is regulated at nominal value V_{cm}, V_{cm} being larger than V_{iacm0},

wherein the value of each inductor Lᵢ is selected according to the formula:

$${L}_{i} \leq \frac{{V}_{iacm 0} \sqrt{{V}_{cm}^{2} - {V}_{iacm 0}^{2}}}{{P}_{im} {ω}_{s}}$$

the value of capacitor Cᵢ is selected according to the formula:

$${C}_{i} = \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages v_{iac} of frequency ωₛ, root mean square line-neutral magnitude V_{iacm} and angle αᵢ, and exchanging power Pᵢ between i-th DC system the hub comprising:

a LC circuit for each phase for each AC/DC converter, wherein each LC circuit comprises an inductor Lᵢ, a capacitor Cᵢ for supplying reactive power and a circuit breaker CBᵢ connected together at their first terminals, the second terminal of each inductor Lᵢ being connected to the respective phase of the respective AC voltage v_{iac}, the second terminal of CBᵢ connected to a common hub AC bus for particular phase, wherein the second terminals of all capacitors are connected to a common point (star point) or they can be connected in delta between other phases or if p=1 to central point of DC voltage,

wherein the voltage of capacitors is regulated at nominal fundamental root mean square line-neutral magnitude of V_{cm}, V_{cm} being larger than V_{iacm0};

and wherein the value of each inductor Lᵢ and capacitor Cᵢ are selected according to any of the above claims and:

V_{iacm} and angle αᵢ are used to control power flow at i-th AC/DC module.

According to an aspect of the invention there is provided an electronic hub for transferring power between n DC systems respectively of DC voltage V_{idc} (i=1, 2, . . . n), where n is any positive integer larger than 1, comprising:

n AC/DC converters for respectively transforming DC voltages V_{idc} into respective p phase AC voltages v_{iac} of frequency ωₛ, root mean square line-neutral magnitude V_{iacm} and angle αᵢ, and exchanging power Pᵢ between i-th DC system the hub comprising:

a LC circuit for each phase for each AC/DC converter, wherein each LC circuit comprises an inductor Lᵢ, a capacitor Cᵢ for supplying reactive power and a circuit breaker CBᵢ connected together at their first terminals, the second terminal of each inductor Lᵢ being connected to the respective phase of the respective AC voltage V_{iac}, the second terminal of CBᵢ connected to a common hub AC bus for particular phase, wherein the second terminals of all capacitors are connected to a common point (star point) or they can be connected in delta between other phases or if p=1 to central point of DC voltage,

wherein the voltage of capacitors is regulated at nominal value V_{cm}, V_{cm} being larger than V_{iacm0},

and wherein the value of each inductor Lᵢ and capacitor Cᵢ are selected according to any of the above claims and:

one or more AC/DC converters are used to regulate V_{c}, at nominal value V_{cm}, and all other modules regulate local powers Pᵢ with additional control loops responding to Vc variation (droop feedback control).

The present invention will now be described with reference to the accompanying drawings in which:—

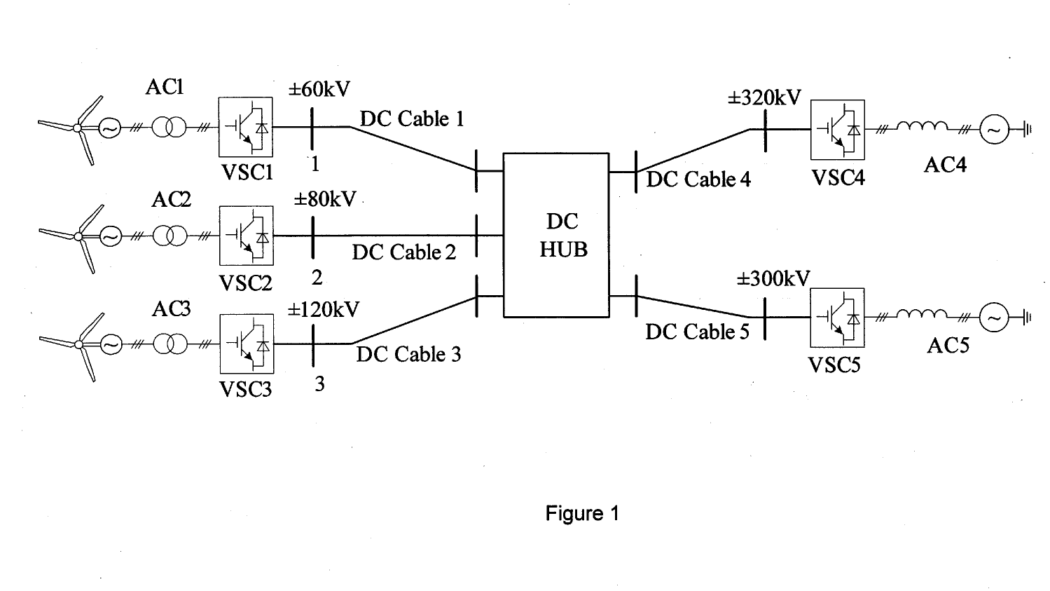

FIG. 1 shows a DC grid connected by a 5-module DC hub;

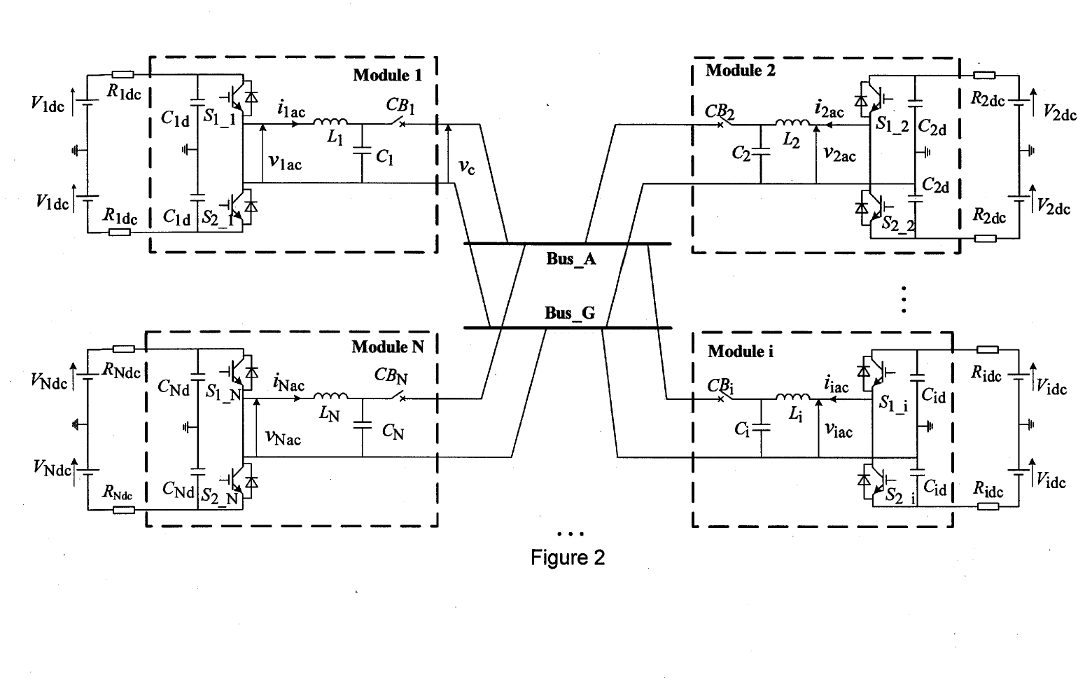

FIG. 2 shows a single phase DC hub topology with N modules;

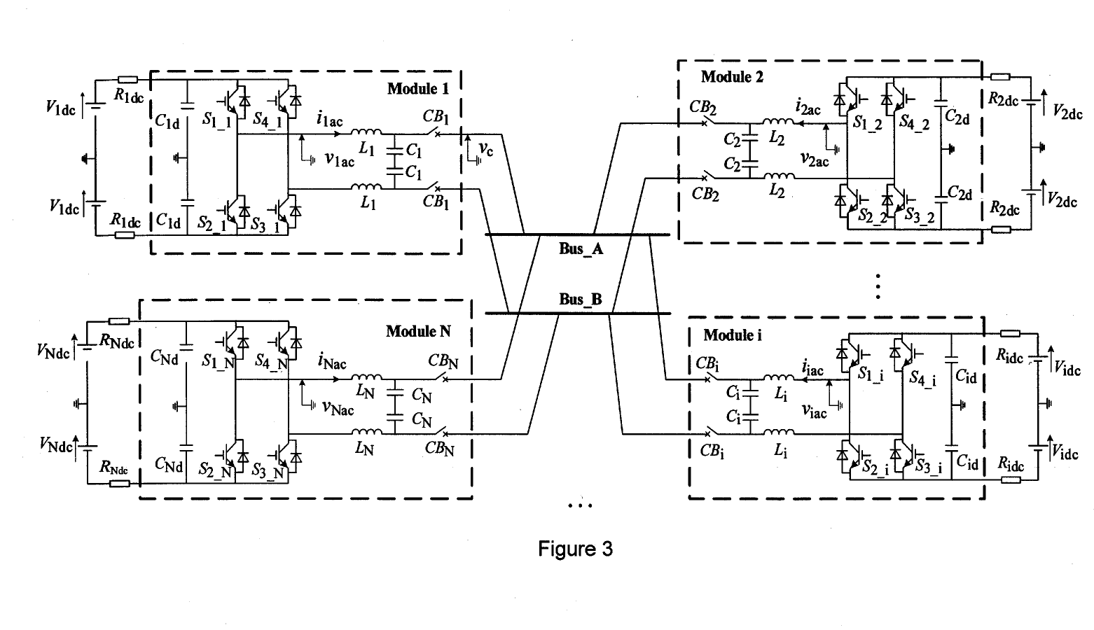

FIG. 3 shows a two phase DC hub topology with N modules;

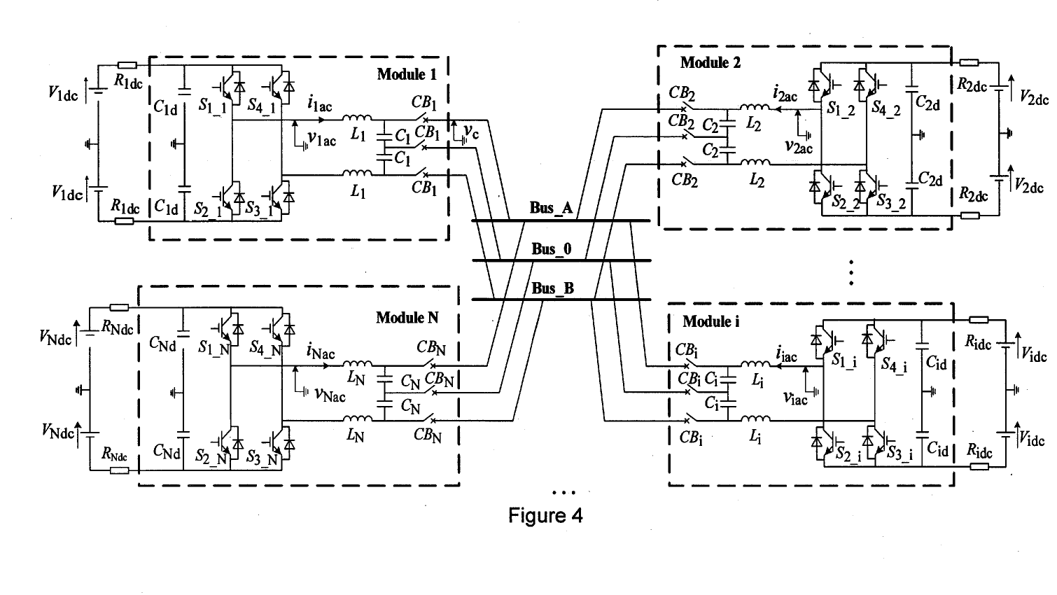

FIG. 4 shows a two phase DC hub topology with N modules and a neutral bus;

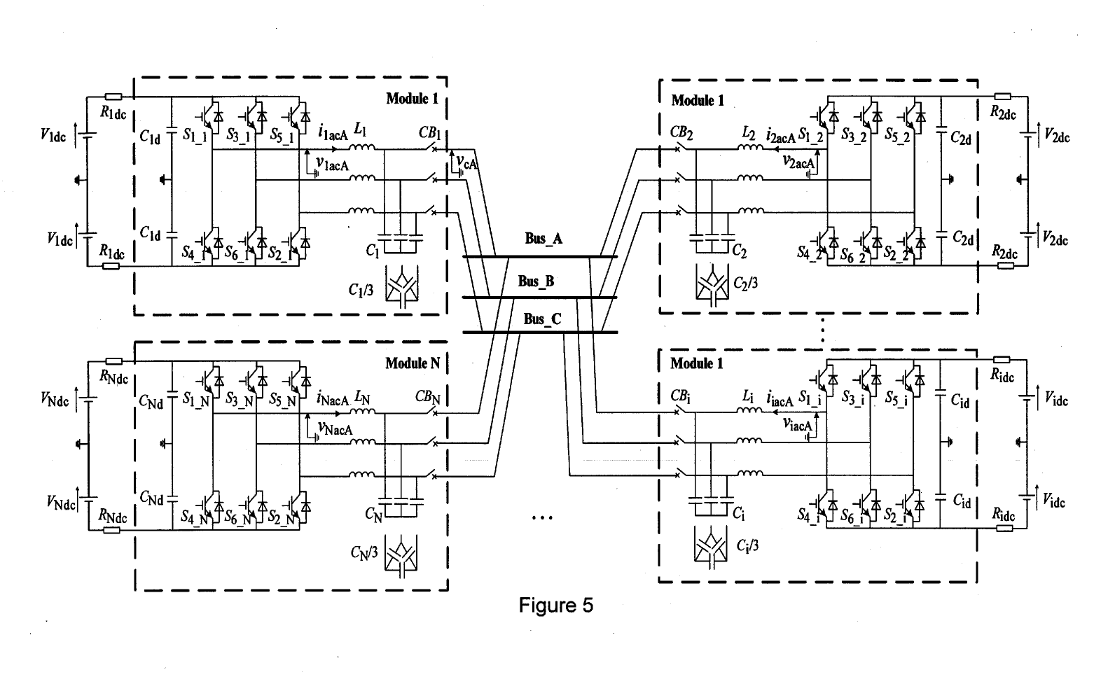

FIG. 5 shows a three phase DC hub topology with N modules and also shows capacitor delta connection;

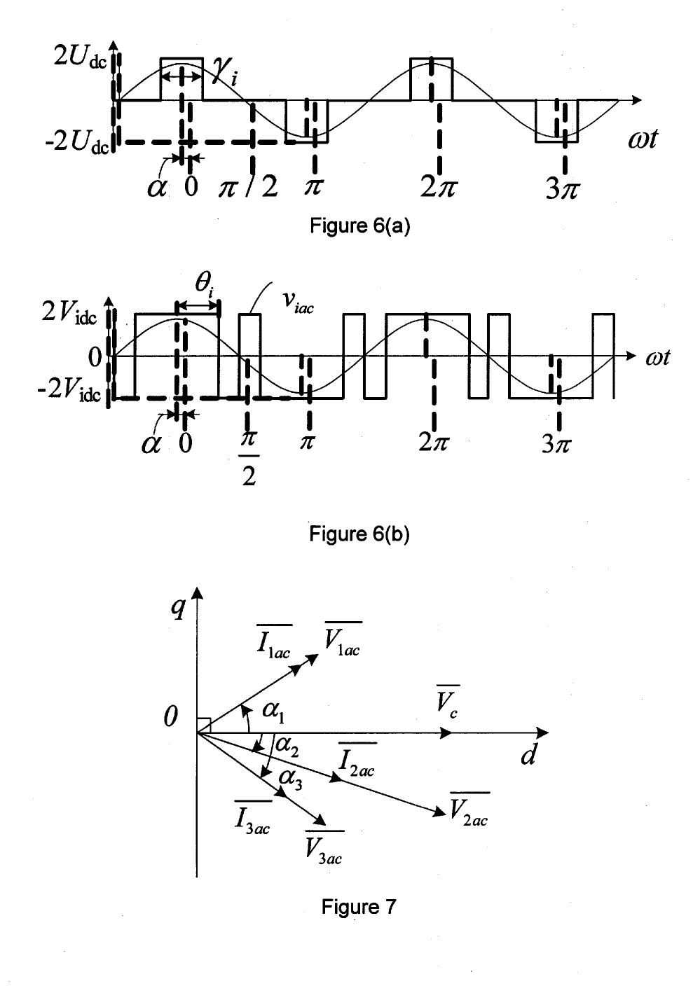

FIG. 6(a) illustrates unidirectional modulation for generating an AC voltage from a DC voltage;

FIG. 6(b) illustrates bidirectional modulation for generating an AC voltage from a DC voltage;

FIG. 7 shows the phasor diagram for a 3-module test system;

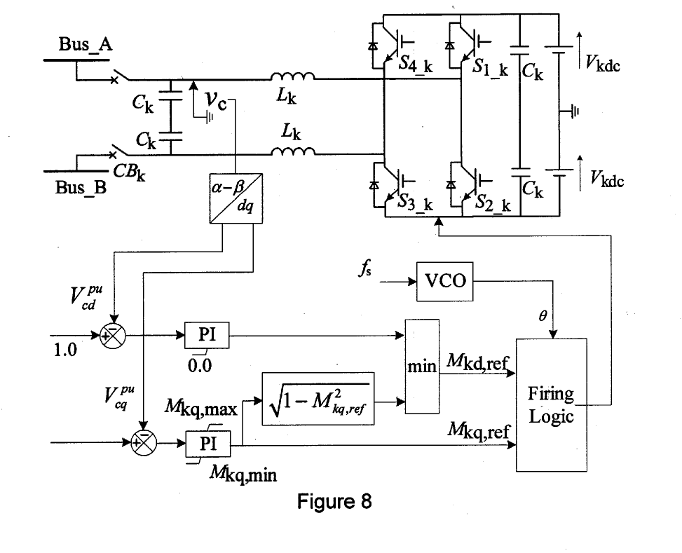

FIG. 8 shows a control schematic for a Voltage Module of a DC hub;

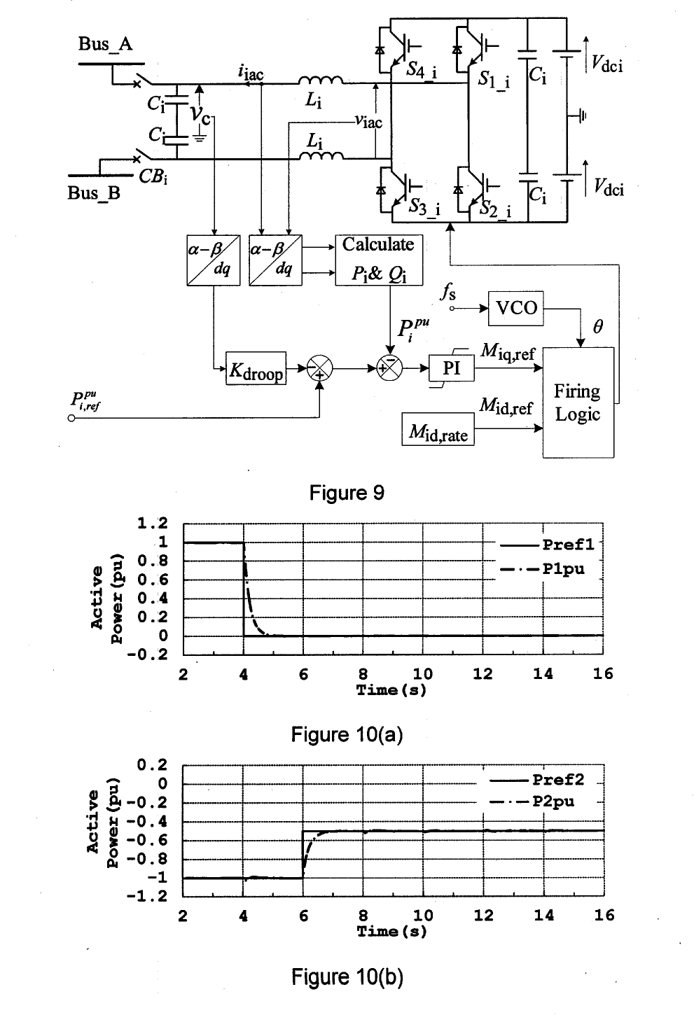

FIG. 9 shows a control schematic for a Power Module of a DC hub;

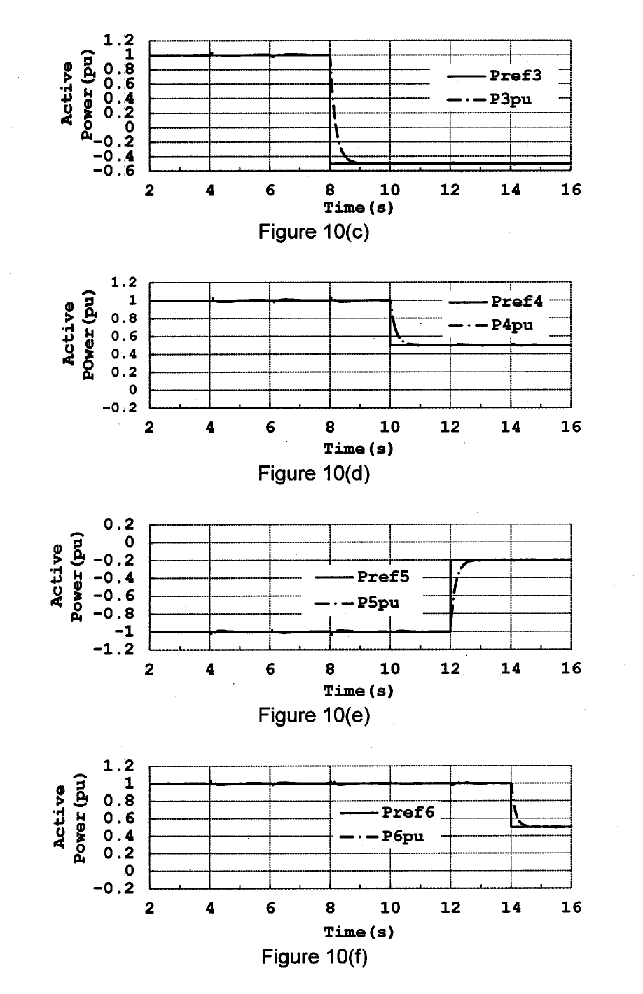

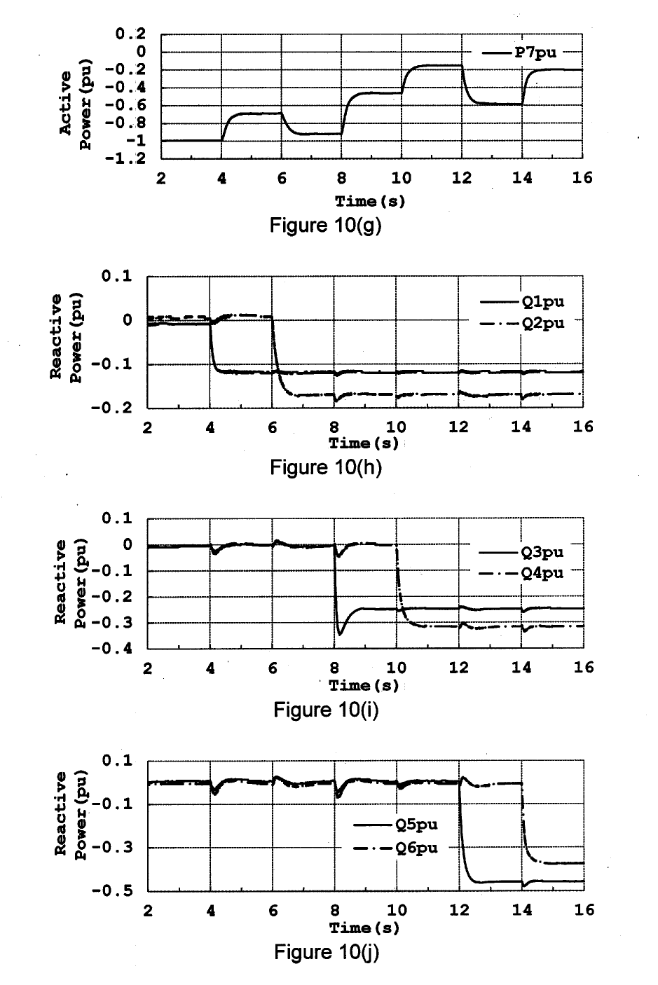

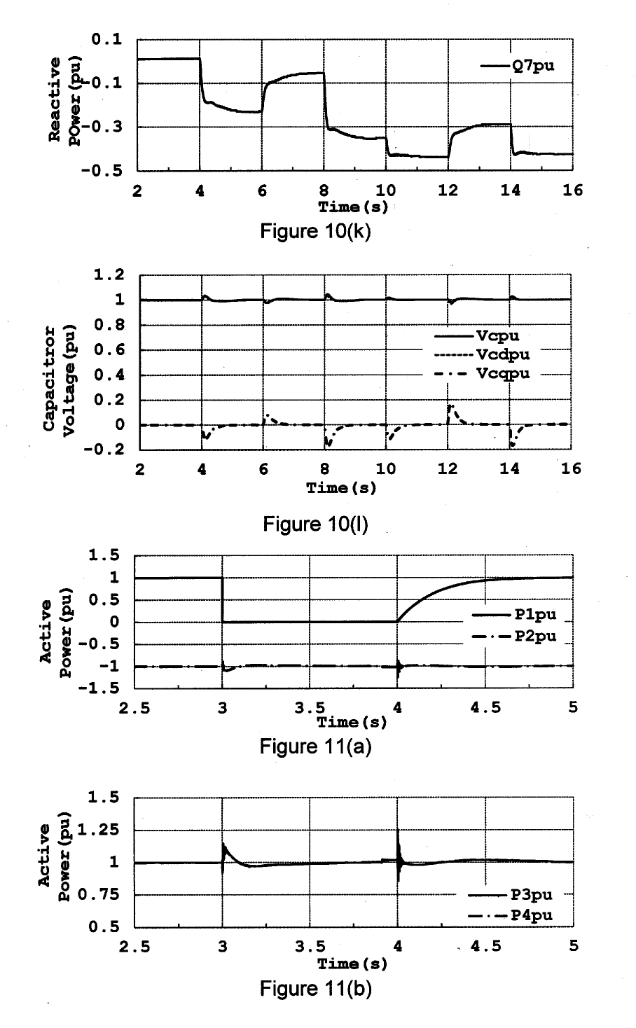

FIGS. 10(a)-10(l) show simulation results for a 7-module DC hub, wherein FIGS. 10(a)-10(g) show active power, FIGS. 10(h)-10(k) show reactive power, and FIG. 10(l) shows the capacitor voltages;

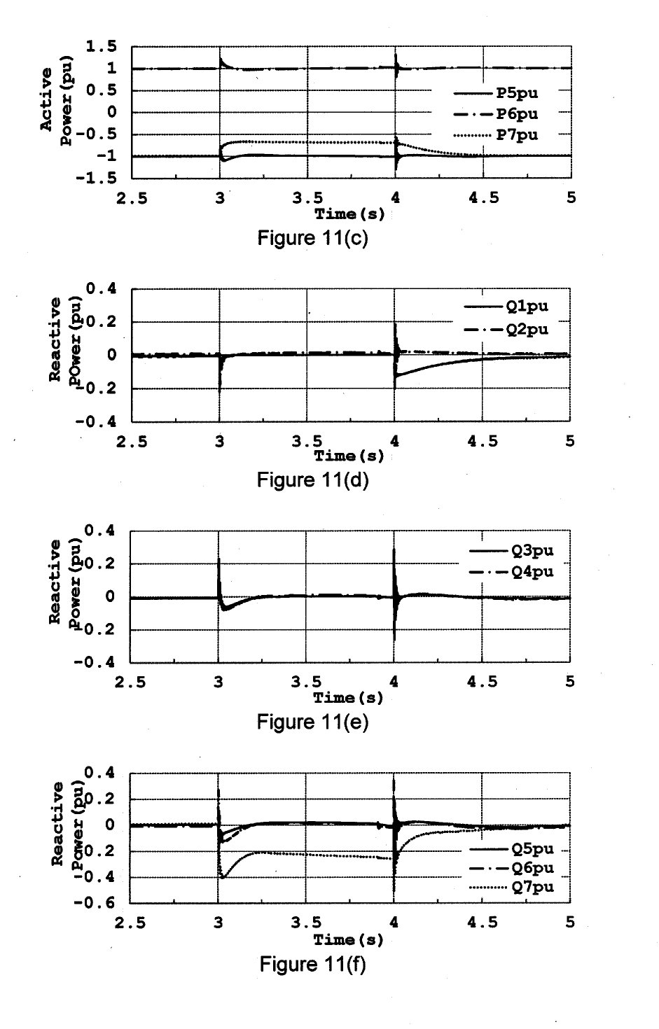

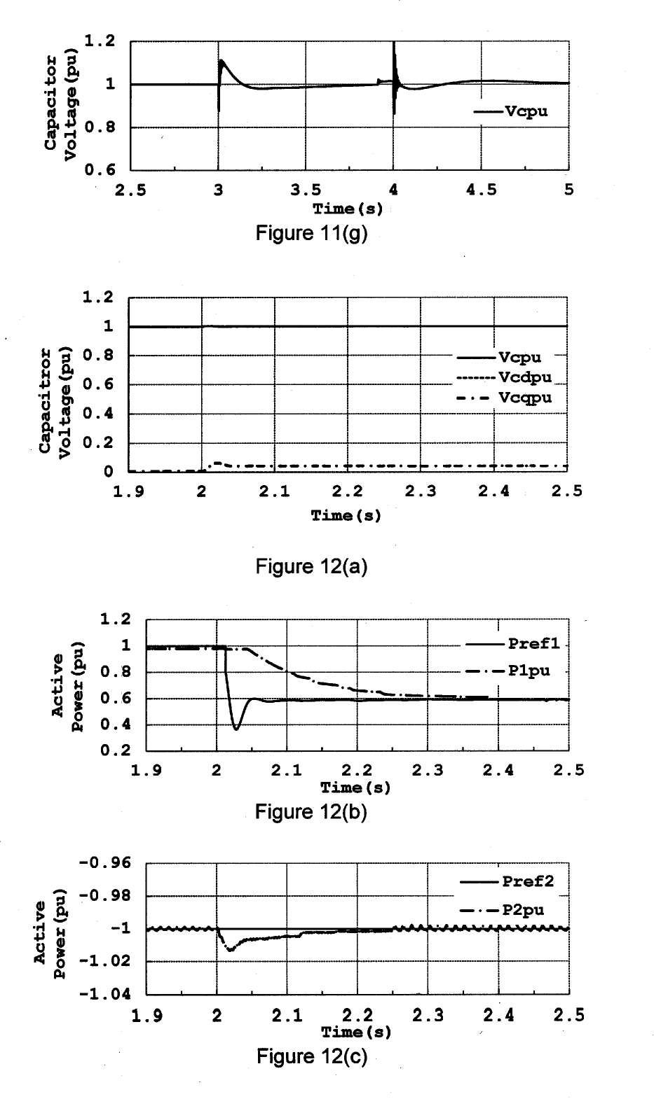

FIGS. 11(a)-11(g) show simulation results which illustrate the effect of isolating and connecting a DC transmission line to a 7-module DC hub, wherein FIGS. 11(a)-11(c) show active power, FIGS. 11(d)-11(f) show reactive power and FIG. 11(g) shows capacitor voltage;

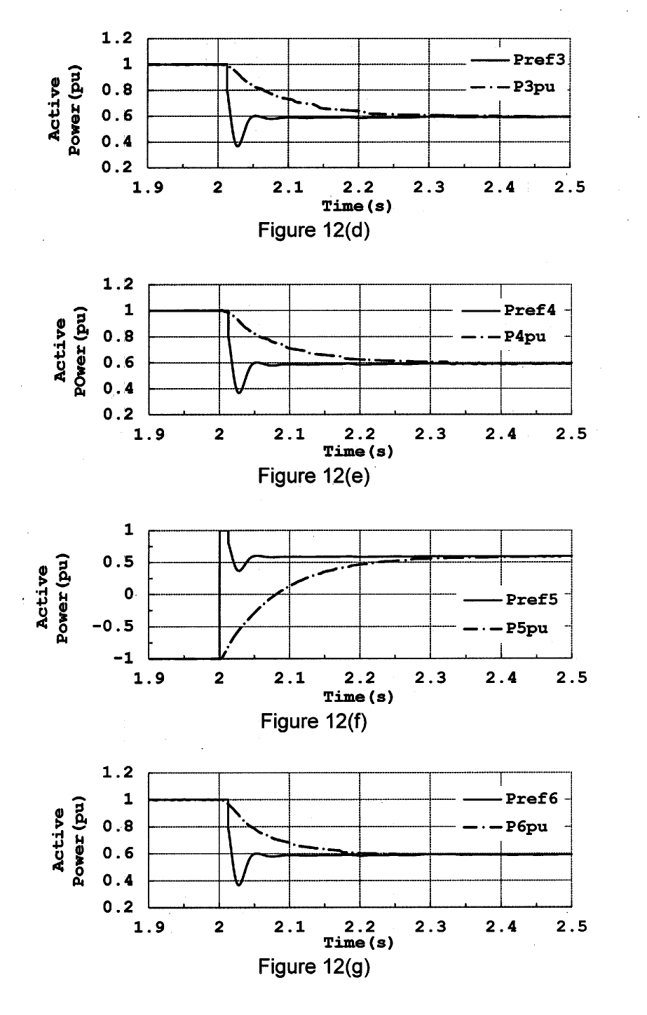

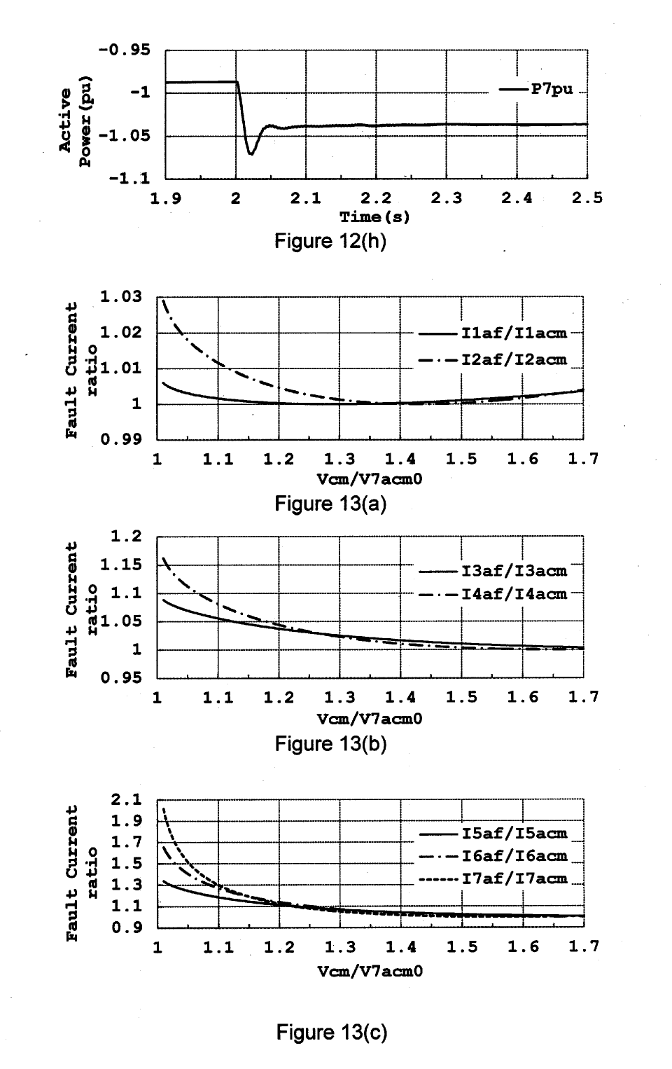

FIGS. 12(a)-12(h) show simulation results which illustrate droop control of the 7-module hub, wherein FIG. 12(a) shows the capacitor voltage of the hub and FIGS. 12(b)-12(h) show the power exchanged at each module;

FIGS. 13(a)-13(c) show simulation results which illustrate the ratio of fault current over rated current for a DC fault at the same module (a DC fault at each module is illustrated);

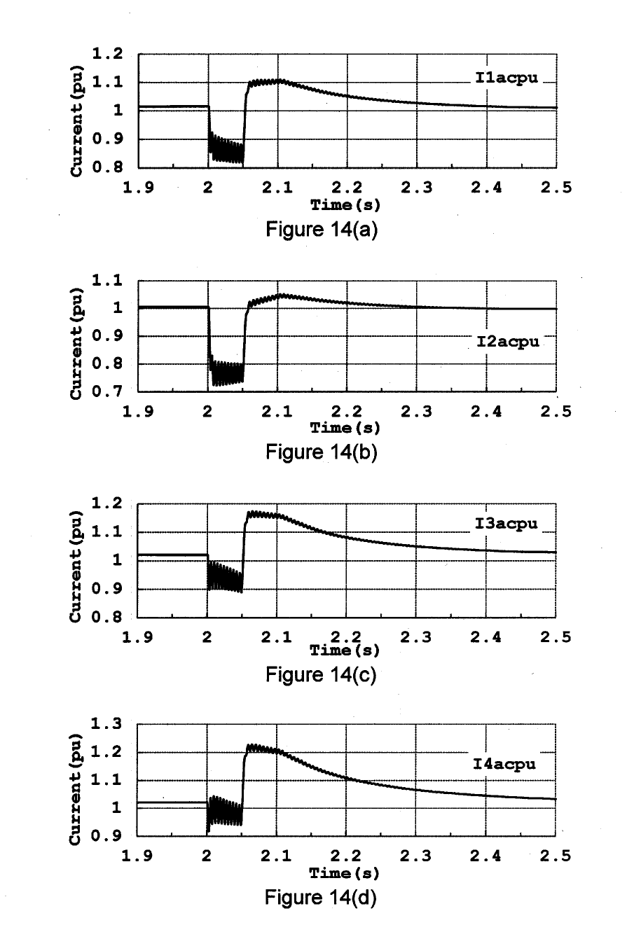

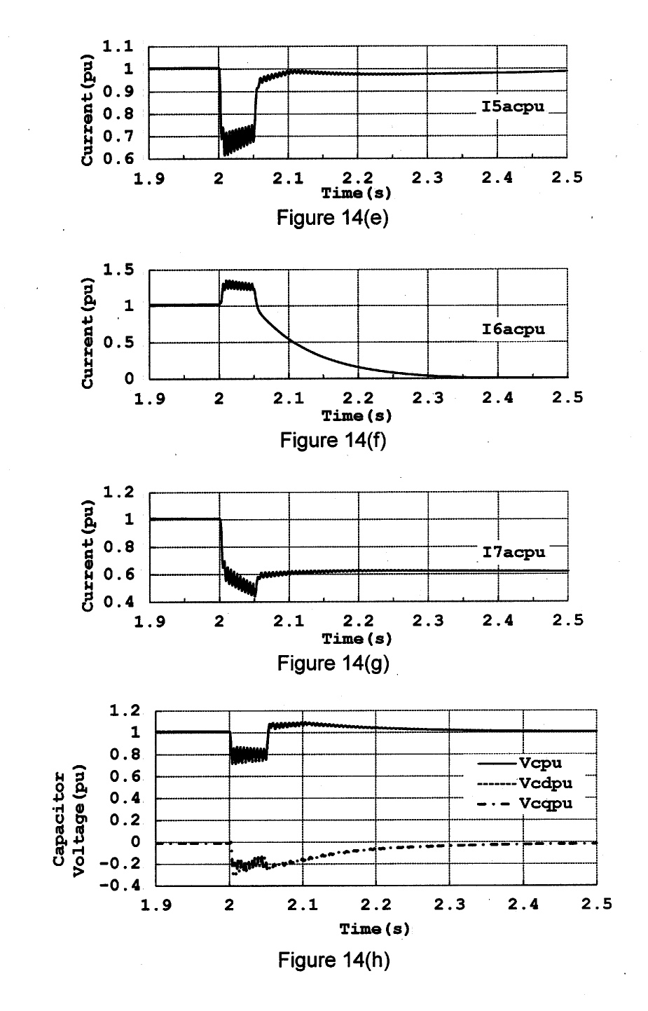

FIGS. 14 (a)-14(h) show simulation results which illustrate the response of a DC hub to a DC fault condition (a permanent DC fault occurs at module 6 at 2.0 s, and module 6 is tripped by its circuit breaker CB₆ at 2.05 s), wherein FIGS. 14(a)-14(g) illustrate AC current of each module and FIG. 14(h) illustrated capacitor voltage.

The term “hub” is used herein in the sense of a common connection point for DC systems.

The term “terminal” is used herein to refer to a contact on an electrical device at which current enters or leaves.

The term “bus” is used to refer to one or more electrical pathways.

FIG. 1 shows a DC-grid which uses a 5-module DC hub. In this example, power is generated by three wind generators, and injected into the hub as DC voltages of ±60 kV, ±80 kV and ±120 kV on DC cables 1, 2 and 3 respectively. Power is drawn from the hub on DC cables 4 and 5 at voltages of ±320 kV and ±300 kV respectively.

FIGS. 2 to 5 show the topology of DC hubs which embody the present invention.

FIG. 2 shows a single phase n-module DC/DC converter or “DC hub” which embodies the present invention.

The hub comprises N modules, represented in FIG. 2 by 4 modules labelled 1, 2, i and N; and a common single phase AC bus with two pathways or busses, Bus_A and Bus_G.

Each module i connects to an external DC system of voltage V_{idc}, with a transmission line represented by bipolar voltage source V_{idc}.

Each module i comprises two switches S₁_{_{—}}ᵢ, S₂_{_{—}}ᵢ arranged as a half-bridge to form a DC/AC converter, an inductor Lᵢ, a capacitor Cᵢ, an AC circuit breaker CBᵢ.

The DC/AC converter of each module i is connected to transform voltage V_{idc} into a single phase AC voltage v_{iac}. In each module, inductor Lᵢ, capacitor Cᵢ and circuit breaker CBᵢ are connected together at their first terminals; the second terminal of inductor Lᵢ is connected to the AC voltage v_{iac}; the second terminal of the circuit breaker CBᵢ is connected to Bus_A; and the second terminal of the capacitor Cᵢ is connected to a Bus_G and to the central point of the bipolar DC voltage V_{idc}.

The module may be considered as having two AC terminals for connection to Bus_A and Bus_G respectively, such that the circuit breaker CBᵢ is connected to Bus_A via a first AC terminal, and the capacitor Cᵢ is connected to Bus_G via a second AC terminal.

Further capacitors C_{id} are optionally provided to filter the harmonics and improve power quality.

FIG. 3 shows a 2-phase DC hub with N modules. The topology is similar to that described in relation to FIG. 2. However, in the topology shown in FIG. 3, the DC/AC converter in each module i comprises four switches S₁_{_{—}}ᵢ, S₂_{_{—}}ᵢ, S₃_{_{—}}ᵢ, S₄_{_{—}}ᵢ arranged as a full bridge (two legs), connected to transform DC voltage V_{idc} into a two phase voltage v_{iac}.

Further, the common 2-phase AC bus comprises one pathway or bus associated with each phase, Bus_A and Bus_B. Further, each module i comprises an additional inductor Lᵢ, an additional capacitor Cᵢ and an additional circuit breaker CBᵢ, compared to the topology in FIG. 2, so that there is one of each per phase.

For each phase, one inductor Lᵢ, one capacitor Cᵢ and one circuit breaker CBᵢ are connected together at their first terminals, the second terminal of the inductor Lᵢ is connected to the respective phase of the AC voltage v_{iac}, and the second terminal of the circuit breaker CBᵢ is connected to the respective phase of the common 2-phase AC bus. The second terminals of the capacitors Cᵢ for both phases are connected together at a common point.

Other aspects of the topology shown in FIG. 3 are as described in relation to FIG. 2.

FIG. 4 shows another 2-phase DC hub with N modules. The topology is similar to that described in relation to FIG. 3, except that the common 2-phase AC bus further comprises a neutral bus, Bus_{—}0. In each module i, the second terminals of the two capacitors Cᵢ are connected to Bus_{—}0. This topology might better share unbalanced conditions between modules.

Other aspects of the topology shown in FIG. 4 are as described in relation to FIG. 3.

FIG. 5 shows a 3-phase DC hub with N modules. The topology is similar to that described in relation to FIGS. 2 and 3. However, in the topology shown in FIG. 5, the DC/AC converter in each module i is formed by six switches S₁_{_{—}}ᵢ-S₆_{_{—}}ᵢ arranged in three legs, connected to transform DC voltage V_{idc} into a three phase voltage v_{iac}. The common 3-phase AC bus comprises three pathways or busses, Bus_A, Bus_B and Bus_C. Thus, there is one bus associated with each phase. Each module i comprises three inductors Lᵢ, three capacitors Cᵢ and three circuit breakers CBᵢ. For each phase, one inductor Lᵢ, one capacitor Cᵢ and one circuit breaker CBᵢ are connected together at their first terminals, the second terminal of the inductor Lᵢ is connected to a respective phase of the AC voltage V_{iac}, and the second terminal of the circuit breaker CBᵢ is connected to the respective phase of the common 3-phase AC bus. The second terminals of the capacitors Cᵢ in all three phases are connected together at a common point. The alternative delta capacitor connection is also shown.

Other aspects of the topology shown in FIG. 5 are as described in relation to FIG. 2.

FIGS. 2 to 5 show DC hubs with N modules, in accordance with embodiments of the present invention. In each figure, 4 modules are depicted. However, it will be appreciated that, in general, N may be any positive integer greater than one. Moreover, it will be appreciated that other variations of the topologies depicted in FIGS. 2 to 5 are possible, for example, with a different number of phases.

In general, for a DC hub with p phases, where p is any positive integer greater than 0, each module i of the hub will comprise a DC/AC converter having 2p switches arranged in p legs for transforming a DC voltage V_{idc} into a p phase voltage V_{iac}, p inductors Lᵢ, p capacitors Cᵢ and p circuit breakers CBᵢ. The hub will comprise a common p-phase AC bus, with one electrical pathway or bus for each phase p. However, additional busses may be present. In each module, and for each phase, one inductor Lᵢ, one capacitor Cᵢ and one circuit breaker CBᵢ are connected together at their first terminals, the second terminal of the inductor Lᵢ is connected to a respective phase of the AC voltage V_{iac}, and the second terminal of the circuit breaker CBᵢ is connected to the common AC bus associated with that phase. The second terminals of the three capacitors Cᵢ in the module are connected together at a common point. Alternatively, the capacitors may be connected in delta between other phases. Each module i takes the angle of common voltage v_{c} as the reference zero phase and generates AC voltage v_{iac} given by:

v_{iac}=\sqrt{2}V_{iac} cos(2πfₛt+αᵢ) (1)

where V_{iac}, fₛ and αᵢ are respectively the fundamental root mean square line-neutral magnitude, switching frequency and phase angle of v_{iac}. The switching frequency fₛ is fixed and common for all modules.

An AC voltage can be generated from a given DC voltage in various ways. For example, using unidirectional pulse width modulation (PWM) as illustrated in FIG. 6a, or bidirectional PWM as illustrated in FIG. 6b. Bidirectional PWM is thought to be particularly suitable with bipolar HVDC.

Derivation of the basic circuit equation is described below. Taking the waveform from FIG. 6b as an example, using Fourier series expansion and neglecting all harmonics, the root means square (RMS) line-neutral AC voltage magnitude V_{iacm} of fundamental component at operating frequency is:

$${V}_{iacm} = \frac{4}{π \sqrt{2}} {V}_{idc} ( 2 sin {θ}_{i} - 1 ) \qquad ( 2 )$$

In a dq frame with the d axis aligned to v the AC voltage vectors of the instantaneous voltage v_{iac} is expressed as:

$$\overline{{V}_{iacm}} = \frac{4}{π \sqrt{2}} {V}_{idc} ( 2 sin {θ}_{i} - 1 ) ∠α i = {V}_{iacd} + j {V}_{iacq} \qquad ( 3 )$$

where V_{iac} is the phasor, V_{iac} is the RMS magnitude and αᵢ is the phase angle of the voltage v_{iac}. The subscripts d and q denote corresponding phasor components in the dq frame, which are calculated using the following equations:

V_{iacd}=V_{iacm0}M_{id}

V_{iacq}=V_{iacm0}M_{iq}

Mᵢ=\sqrt{M_{id}²+M_{iq}²} (4)

where M_{id}, M_{iq} are D-Q components of a generalised control signal. The control signals M_{id} and M_{iq} can be readily linked with αᵢ and θᵢ depending on the chosen AC waveform. V_{iacm0}=4V_{idc}/(π\sqrt{2}) is the maximum RMS magnitude of v_{iac}.

The current equation of the inductor Lᵢ is:

jωₛLᵢ I̅_̅{̅i̅a̅c̅}̅= V̅_̅{̅i̅a̅c̅}̅− V̅_̅{̅c̅}̅ (5)

and the voltage equation of the capacitor is:

$${jω}_{s} \overline{{V}_{c}} {\sum }_{i = 1}^{N} {C}_{i} = {\sum }_{i = 1}^{N} \overline{{I}_{iac}} \qquad ( 6 )$$

where ωₛ=2πfₛ.

For simplicity, the d-axis of the dq frame is assumed to be aligned with the capacitor voltage vector V̅_̅{̅c̅}̅. Therefore, V_{cq}=0, and:

V̅_̅{̅c̅}̅=V_{cd}+jV_{cq}=V_{cd}=V_{c} (7)

where V_{c} is the RMS line neutral AC voltage magnitude of the capacitor voltage v_{c}.

Given the assumption of equation (7) and using equations (3) and (5), the AC current of module i can be expressed as:

$$\begin{matrix}{I}_{iac} = \frac{\overline{{V}_{iac}} - \overline{{V}_{c}}}{{jω}_{s} {L}_{i}} & \\ {I}_{iacd} + j {I}_{iacq} = \frac{{V}_{iacd} + j {V}_{iacq} - {V}_{c}}{{jω}_{s} {L}_{i}} & ( 8 ) \\ {I}_{iacd} + j {I}_{iacq} = \frac{{V}_{iacq}}{{ω}_{s} {L}_{i}} - j \frac{{V}_{iacd} - {V}_{c}}{{ω}_{s} {L}_{i}} & ( 9 )\end{matrix}$$

Given the assumption of equation (7), the capacitor voltage in equation (6) becomes:

$${jω}_{s} {V}_{c} {\sum }_{i = 1}^{N} {C}_{i} = {\sum }_{i = 1}^{N} ( {I}_{iacd} + j {I}_{iacq} ) \qquad ( 10 )$$

FIG. 7 shows the phasor diagram of a 3-module test system (a DC hub with 3 modules) where three AC voltages and currents are shown. It can be seen that the d axis is aligned with V̅_̅{̅c̅}̅. It can also be seen that the current phasors for each module i are in phase with the voltage phasors for that module. This is based on the assumption of zero reactive current at each module.

Design of the LC circuit in each module is described below. The complex power per phase (Sᵢ) at terminal i is:

$$\begin{matrix}{S}_{i} = ( {V}_{iacd} + j {V}_{iacq} ) ( {I}_{iacd} + j {I}_{iacq} ) \\ = {V}_{iacd} {I}_{iacd} + {V}_{iacq} {I}_{iacq} + j ( {V}_{iacq} {I}_{iacd} - {V}_{iacd} {I}_{iacq} )\end{matrix} \qquad ( 11 )$$

The real power per phase Pᵢ is the real part of (11):

Pᵢ=V_{iacd}I_{iacd}+V_{iacd}I_{iacd} (12)

Substituting the expression for current from equation (9) in equation (12) gives:

$$\begin{matrix}{P}_{i} = {V}_{iacd} \frac{{V}_{iacq}}{{ω}_{s} {L}_{i}} - {V}_{iacq} \frac{{V}_{iacd} - {V}_{c}}{{ω}_{s} {L}_{i}} \\ = \frac{{V}_{iacq} {V}_{c}}{{ω}_{s} {L}_{i}}\end{matrix} \qquad ( 13 )$$

From equation (13), a general formula for designing the inductor Lᵢ for each phase can be deduced:

$${L}_{i} = \frac{{V}_{iacq} {V}_{cm}}{{P}_{im}} \qquad ( 14 )$$

where V_{cm} is the rated fundamental root mean square line-neutral magnitude of the capacitor voltage, Pᵢₘ is the maximum power per phase and V_{iacq} is pre-selected according to other design requirements.

The capacitor for each phase Cᵢ is designed to compensate the reactive current generated by Lᵢ at maximum power condition. From equations (9) and (10):

$$\begin{matrix}{ω}_{s} {V}_{cm} {C}_{i} = \frac{{V}_{cm} - {V}_{iacd}}{{ω}_{s} {L}_{i}} & ( 15 ) \\ {C}_{i} = \frac{{V}_{cm} - {V}_{iacd}}{{ω}_{s}^{2} {V}_{cm} {L}_{i}} & ( 16 )\end{matrix}$$

where V_{iacd} is pre-selected according to other design requirements.

Equations (14) and (16) are general formulas for calculating Lᵢ and Cᵢ, wherein V_{iacd} and V_{iacq} are any positive values that also satisfy the inequality V_{iacd}²+V_{iacq}²≦V_{iacm0}².

The hub is preferably designed to achieve zero reactive power at module i, when that module is operating at maximum power. This minimises current magnitude and therefore minimises switching and conduction losses. The condition for zero reactive power at module i implies:

$$∠ \overline{{V}_{iac}} = ∠ \overline{{I}_{iac}} \\ \frac{{V}_{iacq}}{{V}_{iacd}} = \frac{{I}_{iacq}}{{I}_{iacd}} \qquad ( 17 )$$

Substituting the expression for current from equation (9) in equation (17) gives:

$$\begin{matrix}\frac{{V}_{iacq}}{{V}_{iacd}} = \frac{{V}_{iacd} - {V}_{c}}{- {V}_{iacq}} \\ - {V}_{iacq}^{2} = {V}_{iacd}^{2} - {V}_{iacd} {V}_{c} & ( 18 ) \\ {V}_{iacm}^{2} = {V}_{iacd} {V}_{c} & ( 19 )\end{matrix}$$

Substituting equation (4) into equation (19) gives the zero reactive power condition expressed in terms of control signals:

(M_{id}²+M_{iq}²)V_{iacm0}=M_{id}V_{c} (20)

Rearranging equation (3) and squaring gives:

Pᵢ²ωₛ²Lᵢ²=V_{iacq}²V_{c}² (21)

Taking the square of equation (19) and adding to equation (21) gives:

Pᵢ²ωₛ²Lᵢ²+V_{iac}⁴=V_{iacq}²V_{c}²+V_{iacd}²V_{c}²

Pᵢ²ωₛ²Lᵢ²+V_{iac}⁴=V_{iac}²V_{c}² (22)

The inductor Lᵢ is designed to enable maximum (rated) power transfer at the respective module. Substituting V_{iac} with V_{iacm0}, Pᵢ with Pᵢₘ and V_{c} with V_{cm}, gives:

Pᵢₘ²ωₛ²Lᵢ²+V_{iacm0}⁴=V_{iacm0}²V_{cm}² (23)

where Pᵢₘ is the maximum power per phase of module i and V_{cm} is the maximum RMS line neutral AC voltage magnitude of the capacitor voltage v_{c}. V_{cm} may be selected as a first design step, since the design below is valid for any V_{cm}. Equation (23) can be rearranged in the following form:

Pᵢₘ²ωₛ²Lᵢ²=V_{iacm0}²(V_{cm}²−V_{iacm0}²) (24)

Equation (24) indicates that V_{cm} should be larger than any V_{iacm0}, otherwise the term Pᵢₘ²ωₛ²Lᵢ² will be less than zero, which never holds. Equation (24) allows Lᵢ to be calculated under the condition of zero reactive power, according to:

$${L}_{i} = \frac{{V}_{iacm 0} \sqrt{{V}_{cm}^{2} - {V}_{iacm 0}^{2}}}{{P}_{im} {ω}_{s}} \qquad ( 25 )$$

Using the capacitor voltage equation (6), and assuming a maximum capacitor voltage V̅c̅=Vcm,

$${jω}_{s} {V}_{cm} {\sum }_{i = 1}^{N} {C}_{i} = {\sum }_{i = 1}^{N} {I}_{iacd} + j {\sum }_{i = 1}^{N} {I}_{iacq} \qquad ( 26 )$$

Separating equation (26) into real and imaginary components gives:

$$\begin{matrix}{jω}_{s} {V}_{cm} {\sum }_{i = 1}^{N} {C}_{i} = j {\sum }_{i = 1}^{N} {I}_{iacq} & ( 27 ) \\ {\sum }_{i = 1}^{N} {I}_{iacd} = 0 & ( 28 )\end{matrix}$$

Equation (27) indicates that the total reactive current from all modules (I_{iacq}) should be balanced by the reactive current generated by the capacitors. One way to achieve this is to let each local Cᵢ balance the reactive current generated by each I_{iacq}, ie:

jωₛV_{cm}Cᵢ=jI_{iacq} (29)

Substituting the expression for current from equation (9) into equation (29) gives:

$${ω}_{s} {V}_{cm} {C}_{i} = \frac{{V}_{cm} - {V}_{iacd}}{{ω}_{s} {L}_{i}} \qquad ( 30 )$$

Multiplying both sides of equation (30) by V_{cm} and considering the requirement for zero reactive power at maximum power, gives:

$$\begin{matrix}{ω}_{s} {V}_{cm}^{2} {C}_{i} = \frac{{V}_{cm}^{2} - {V}_{iacm 0}^{2}}{{ω}_{s} {L}_{i}} & ( 31 ) \\ {C}_{i} = \frac{{V}_{cm}^{2} - {V}_{iacm 0}^{2}}{{ω}_{s}^{2} {V}_{cm}^{2} {L}_{i}} & ( 32 )\end{matrix}$$

Substituting Lᵢ from equation (25) in equation (32) gives an equation for the size of capacitor Cᵢ in terms terminal power Pᵢₘ, terminal voltage V_{iacm0} and V_{cm}.

$${C}_{i} = \frac{1}{{ω}_{s} {V}_{cm}^{2}} \frac{{P}_{im} \sqrt{{V}_{cm}^{2} - {V}_{iacm 0}^{2}}}{{V}_{iacm 0}} \qquad ( 33 )$$

Equations (25) and (33) allow calculation of values for Lᵢ and Cᵢ that minimize current of each module at maximum power. However, a lower value for Lᵢ will also transmit power Pᵢₘ, if according to equation (13), V_{iacq} is reduced. Lower V_{iacq} implies under-utilisation of converters. However, lower V_{iacq} may be required to provide some control margin or to account for internal losses. Thus, a value for Lᵢ that is lower than the value given by equation (25) can also be used. Furthermore, according to equation (16), if V_{iacd} is kept unchanged, Cᵢ needs to be increased if Lᵢ is reduced. Thus, values of Lᵢ and Cᵢ that satisfy the following two inequalities can also be used to transmit power Pᵢ to the hub.

$${L}_{i} \leq \frac{{V}_{iacm 0} \sqrt{{V}_{cm}^{2} - {V}_{iacm 0}^{2}}}{{P}_{im} {ω}_{s}} \qquad ( 34 )$$

the value of capacitor Ci is selected according to the formula:

$${C}_{i} \geq \frac{{V}_{cm}^{2} - {V}_{iacm 0}^{2}}{{ω}_{s}^{2} {V}_{cm}^{2} {L}_{i}} \qquad ( 35 )$$

By summing equation (33) from i=0 to i=N, the total capacitor of the hub is:

$$C = {\sum }_{i = 1}^{N} {C}_{i} = \frac{- {\sum }_{i = 1}^{N} \frac{{V}_{iacm 0}^{2}}{{L}_{i}}}{{ω}_{s}^{2} {V}_{cm}^{2}} + \frac{{\sum }_{i = 1}^{N} \frac{1}{{L}_{i}}}{{ω}_{s}^{2}} \qquad ( 36 )$$

As discussed in more detail below, the hub of the present invention is both expandable and flexible in the sense that modules may be connected and disconnected, without disruption to the overall operation of the hub.

AC voltage magnitude V_{cm} and switching frequency ωₛ are fixed. If the hub is designed according to the methods outlined above, it can be seen from equation (25) that Lᵢ only depends on V_{iacm0} and Pᵢₘ. That is to say, it does not depend on parameters associated with any other module than the one to which it belongs. Further, no matter how many other modules are connected or disconnected, the local power flow at a module is solely dependent on V_{cm}, V_{iacm} and Lᵢ. Thus, modules can be readily connected to or disconnected from the DC hub without the need to change the inductor Lᵢ or capacitor Cᵢ in any of the other modules.

When a module i is added, the required additional capacitor Cᵢ can be determined according to equation (33). It is only required that the AC voltage magnitude of the new module is lower than the magnitude of the capacitor voltage V_{cm}, according to equation (24).

If a module is tripped from the DC hub, the required reduction in capacitor will be according to equation (33). Therefore, a circuit breaker CBᵢ is included, located at the bus side of Cᵢ, which enables module i to be connected or disconnected without affecting the basic operating principles of the remaining terminals.

In designing the DC hub, the maximum power and rated DC voltage of each module are known a priori, operating frequency and capacitor AC voltage are independently selected, and the inductance and capacitance of each terminal need to be determined.

According to equations (25) and (33), the only independent variable in the designing stage is the AC voltage of the capacitor, assuming fₛ is initially fixed. After selecting V_{cm}, inductances and capacitance will be calculated according to equations (25) and (33) using the maximum power condition for each module i. These equations enable zero reactive power at each module under maximum power for that module.

According to equation (25), V_{cm} should be larger than V_{iacm0}. Thus, V_{cm} should be greater than the maximum fundamental root mean square line-neutral voltage magnitude at any terminal. Although, in principle, any V_{cm} can be selected, a high value for V_{cm} has cost penalties. Very low V_{cm} may cause control difficulties. The best overall performance is typically obtained if V_{cm} is chosen to be around 20% higher than the maximum V_{iacm0}. After selecting V_{cm}, each Lᵢ and Cᵢ is calculated according to equations (25) and (33).

Control of the hub is described below. In the previous analysis, hub design is based on rated power levels. At each module i, active and reactive power can be controlled independently using the two control signals M_{id} and M_{iq}. According to equation (13), M_{iq} (V_{iacq}) is used to control Pᵢ. Similarly, according to equation (11), M_{id} is used to control reactive power.

In an N terminal hub according to an embodiment of the present invention, one module may be used to maintain power balance within the hub by regulating capacitor voltage v_{c}, whilst the other modules control their local power. The module in which v_{c} is controlled may be referred to as the “Voltage Module”, whilst the other modules may be referred to as “Power Modules”.

In normal operation, each module can independently demand local power. However, the sum of all power over all modules connected to the hub must be zero, as the power input of the system must be equal to the power output. Accordingly, a central master controller is provided for moderating demanding powers and calculating power orders which are assigned to controllers at each of the modules. For example, if a module k operates as the Voltage Module, and the other modules operate as Power Modules, then the master controller ensures that the sum of all power orders for the Power Modules stays within the rating of the Voltage Module. That is to say:

$$\vert {\sum }_{i = 1 , i \neq k}^{N} {P}_{i}^{ref} \vert \leq \vert {P}_{km}^{ref} \vert \qquad ( 37 )$$

where injecting power into the common AC bus is defined as the positive direction.

From the capacitor voltage equations (6):

$$\begin{matrix}\begin{matrix}jω ( {V}_{cd} + {jV}_{cq} ) C = {\sum }_{i = 1}^{N} ( {I}_{iacd} + j {I}_{iacq} ) \\ = {\sum }_{i = 1}^{N} \frac{( {V}_{iacd} + j {V}_{iacq} ) - ( {V}_{cd} + j {V}_{cq} )}{{jω}_{s} {L}_{i}}\end{matrix} & ( 38 ) \\ - {ω}_{s} {V}_{cq} C = {\sum }_{i = 1}^{N} \frac{{V}_{iacq} - {V}_{cq}}{{ω}_{s} {L}_{i}} \\ - {ω}_{s} {V}_{cd} C = {\sum }_{i = 1}^{N} \frac{{V}_{iacd} - {V}_{cd}}{{ω}_{s} {L}_{i}} & ( 39 )\end{matrix}$$

Equation (39) may be arranged in the following form:

$$( {\sum }_{i = 1}^{N} \frac{1}{{ω}_{s} {L}_{i}} - {ω}_{s} C ) {V}_{cq} = {\sum }_{i = 1}^{N} \frac{{V}_{iacq}}{{ω}_{s} {L}_{i}} \\ ( {\sum }_{i = 1}^{N} \frac{1}{{ω}_{s} {L}_{i}} - {ω}_{s} C ) {V}_{cd} = {\sum }_{i = 1}^{N} \frac{{V}_{iacd}}{{ω}_{s} {L}_{i}} \qquad ( 40 )$$

A variable K_{c} may be defined as:

$${K}_{c} = {\sum }_{i = 1}^{N} \frac{1}{{ω}_{s} {L}_{i}} - {ω}_{s} C \qquad ( 41 )$$

Substituting equation (36) into equation (41) gives:

$$\frac{{K}_{c}}{{ω}_{s}} = {\sum }_{i = 1}^{N} \frac{1}{{ω}_{s}^{2} {L}_{i}} - C = \frac{{\sum }_{i = 1}^{N} \frac{{V}_{iacm 0}^{2}}{{L}_{i}}}{{ω}_{s}^{2} {V}_{cm}^{2}} \qquad ( 42 )$$

Equation (42) indicates that K_{c}>0. If a module k is selected to maintain V_{c}, equations (40) can be rewritten as follows:

$$\begin{matrix}{K}_{c} {V}_{cq} = {\sum }_{i = 1 , i \neq k}^{N} \frac{{V}_{iacq}}{{ω}_{s} {L}_{i}} + \frac{{V}_{kacq}}{{ω}_{s} {L}_{k}} = {\sum }_{i = 1 , i \neq k}^{N} \frac{{V}_{iacq}}{{ω}_{s} {L}_{i}} + \frac{{V}_{kacm}}{{ω}_{s} {L}_{k}} & ( 43 ) \\ {K}_{c} {V}_{cd} = {\sum }_{i = 1 , i \neq k}^{N} \frac{{V}_{iacd}}{{ω}_{s} {L}_{i}} + \frac{{V}_{kacd}}{{ω}_{s} {L}_{k}} = {\sum }_{i = 1 , i \neq k}^{N} \frac{{V}_{iacd}}{{ω}_{s} {L}_{i}} + \frac{{V}_{kacm}}{{ω}_{s} {L}_{k}} & ( 44 )\end{matrix}$$

M_{kq} and M_{kd} are used to maintain V_{cq} and V_{cd} respectively.

FIG. 8 shows a control schematic for the Voltage Module k. The reference angle for the firing logic of the voltage terminal comes from a voltage controlled oscillator (VCO). Thus θₛ=2πfₛt, where fₛ is the switching frequency of the hub.

Equation (13) may be rewritten:

$${P}_{i} = \frac{{V}_{iacm 0} {M}_{iq} {V}_{c}}{{ω}_{s} {L}_{i}} \qquad ( 45 )$$

Thus, Pᵢ can be controlled by manipulating the q-axis modulation index M_{iq}. Also, from equation (45), it can be seen that V_{cm} must be at the rated value at all times in order to enable rated power transfer at each terminal. At rated power, Pᵢ_{_{—}}ᵣₐₜₑ, the q-axis control index is:

$${M}_{iq\_rate} = \frac{{P}_{i\_rate} {ω}_{s} {L}_{i}}{{V}_{iacm 0} {V}_{cm}} \qquad ( 46 )$$

According to the zero reactive power condition of equation (20):

V_{iacd}²+V_{iacq}²=V_{iacd}V_{c} (47)

Referring to the active power equation (13), V_{iacq} should be reduced to reduce the active power Pᵢ. To maintain zero reactive power at module i, equation (47) indicates that V_{iacd} should also be reduced, following the reduction of V_{iacq}.

However, referring to the capacitor voltage equation (44), if V_{iacd} for each of the Power Modules is reduced, M_{kd} of the Voltage Module would need to be increased. This may not be allowed, as it may exceed its limit, with the result that V_{cd} would be lower than its rated value. If V_{cd} is decreased, the capability of the Power Modules to transmit active power is reduced. It is possible for some modules to transmit partial power while other terminals transmit rated power. If V_{cd} is lowered, the requirement for the hub to transmit active power is not satisfied.

To ensure that V_{c} is maintained at its rated value V_{cm}, all V_{iacd} are maintained at their rated values. Thus:

M_{id}=M_{id}_{_{—}}ᵣₐₜₑ={square root over (1−M_{iq}_{_{—}}ᵣₐₜₑ²)} (48)

FIG. 9 shows a control schematic for the Power Modules. Each Power Module is used to control its transmitted active power to the power reference P_{i,ref}^{pu}. The power reference could be manually set or come from an upper layer supervising system. M_{id} is maintained at its rated value according to equation (48). The reference angle for firing logic θ comes from a voltage controlled oscillator (VCO). Thus, θₛ=2πfₛt, where fₛ is the switching frequency of the hub.

In FIG. 9, the power control loop also employs droop control feedback (K_{droop}). The droop control is required to ensure that:

1) The hub maintains some voltage control, and thus prevents collapse if the Voltage Module is lost;

2) V_{c} regulation is shared among all modules in order to avoid saturation of the Voltage Module;

3) The hub voltage is maintained close to rated values in case the master hub control is lost.

The values for the droop gains are calculated to ensure that capacitor voltage is within the required range in the worst case operating conditions, such as tripping of the Voltage Module, or unfavourable power demand at every Power Module.

Fault current analysis of a hub which embodies the present invention is discussed below. The capacitor voltage during normal operation is, from (5) and (6):

$$\begin{matrix}\overline{{V}_{c}} = {V}_{cd} + j {V}_{cq} = \frac{{\sum }_{i = 1}^{N} \frac{\overline{{V}_{iac}}}{{L}_{i}}}{D} = \frac{{\sum }_{i = 1}^{N} \frac{{M}_{id} {V}_{iacm 0} + j {M}_{iq} {V}_{iacm 0}}{{L}_{i}}}{D} \\ where & ( 49 ) \\ D = {\sum }_{i = 1}^{N} \frac{1}{{L}_{i}} - {ω}_{s}^{2} C & ( 50 )\end{matrix}$$

Current at module i is:

$${I}_{iacd} + j {I}_{iacq} = \frac{{V}_{cq} - {V}_{iacq}}{{ω}_{s} {L}_{i}} + j \frac{{V}_{cd} - {V}_{iacd}}{{ω}_{s} {L}_{i}} = \frac{{V}_{cq} - {M}_{iq} {V}_{iacm 0}}{{ω}_{s} {L}_{i}} + j \frac{{V}_{cd} - {M}_{id} {V}_{iacm 0}}{{ω}_{s} {L}_{i}} \\ \qquad ( 51 )$$

If a DC fault happens at module i, the voltage becomes V_{iacm0}=0. Substituting this condition in equation (50) gives the expression of V̅_̅{̅c̅}̅ when a module i is at fault. Substituting V_{iacm0}=0 and equation (50) in equation (51) gives the expression for current at the faulted terminals and at other terminals for a fault at module i.

Although direct analytical formula for magnitude of fault currents cannot be derived, extensive simulations have been performed using detailed simulation models. In all tested cases, with realistic parameters, the fault current is around 1.1-1.3 pu of the rated current. This is a significant conclusion because semiconductors can withstand this small overcurrent, and there is no need to trip terminals or the hub for DC faults.

Detailed simulation of a 7-module DC hub in PSCAD/EMTDC is used to validate the design and control of the hub. DC voltage rating and power rating of the hub is shown in Table 1. Modules 1-6 are Power Modules and module 7 is the Voltage Module.

The capacitor voltage V_{cm} is 755.9 kV (V_{cm}/V_{7acm0}=1.2, V_{7acmo} is the maximum value among each V_{i acm0}) and the switching frequency is 1250 Hz.

In table 1, power injected into the hub is defined as the positive power direction (1).

TABLE 1

| Termi- | | | | | | | |
|---|---|---|---|---|---|---|---|
| nal | 1 | 2 | 3 | 4 | 5 | 6 | 7 |
| V_{DC} | 100 | 200 | 300 | 400 | 500 | 600 | 700 |
| (kV) | | | | | | | |
| P | 200 | 300 | 200 | 400 | 350 | 500 | 600 |
| (MW) | | | | | | | |
| Lᵢ (H) | 0.086 | 0.112 | 0.243 | 0.152 | 0.199 | 0.145 | 0.103 |
| Cᵢ (μF) | 0.186 | 0.136 | 0.058 | 0.082 | 0.053 | 0.055 | 0.048 |
| Power | 1 | −1 | 1 | 1 | −1 | 1 | −1 |
| Direc- | | | | | | | |
| tion | | | | | | | |

FIGS. 10(a)-10(l) show simulation results for the 7-module hub. Step changes of the power orders of modules 1-6 are applied sequentially at t=4 s with an interval of 2 s.

FIGS. 10(a)-10(g) show that each Power Module can transmit rated power. At each module, the power follows the power order correctly and power levels at other modules are unaffected. In FIGS. 10(a)-10(g), the active power references P_{ref1}-P_{ref7} and the measured active power P₁ₚᵤ-P₇ₚᵤ are per unit values taking the rated power of each module in Table 1 as the base value.

FIGS. 10(h)-10(k) show the curves of reactive power. From 2 s to 4 s, all the modules operate at full power, and it can be seen that zero reactive power is achieved at this full power condition. Similar to FIGS. 10(a)-10(g), each of Q₁ₚᵤ-Q₇ₚᵤ are per-unit values taking the rated power of each module in Table 1 as the base value.

FIG. 10(l) shows the capacitor voltages. The magnitude (V_{cpu}) and d component of capacitor voltage (V_{cdpu}) is maintained at 1 pu whilst the q component of capacitor voltage (V_{cqpu}) is maintained at zero in steady state at all operating points. Each of the V_{cpu}, V_{cdpu} and V_{cqpu} are per-unit values taking V_{cm} as the base value.

FIGS. 11(a)-11(g) show the effect of isolating and connecting a DC transmission line (with an associated module) to the hub. Module 1 is tripped from the hub at 3.0 s and reconnected to the hub at 4.0 s. Before module 1 is tripped, each Power Module operates at its rated power and the Voltage Module maintains v_{c}. When module 1 is tripped, P₁ₚᵤ reduces to 0.0 as expected. Active power of the Voltage Module (module 7) automatically changes to balance the active power of the hub. It is observed that active power of the other power modules (modules 2-6) remains unchanged regardless of the connection status of module 1. V_{c} is also unchanged in steady state. The reactive power of the other power modules (modules 2-6) remains zero, regardless of the tripping or connection of module 1.

FIGS. 12(a)-12(h) show the performance of droop control. Before 2.0 s, all the Power Modules (modules 1-6) operate at full power. Power direction of module 5 is the same as the Voltage Module (module 7). At 2.0 s, the sign of power reference at module 5 (P_{ref5}) is reversed (i.e. module 5 changes from absorbing to injecting). As a result, there is an imbalance between the power orders. The droop control decreases the magnitude of power order at the modules injecting power into the hub, and increases the magnitude of power orders of the modules absorbing power from the hub.

FIG. 12(a) shows that the capacitor voltage of the hub V_{cq} is non-zero as expected. The magnitude of v_{c} is maintained at almost 1 pu.

FIGS. 12(b)-12(h) show the active power of all the modules. It can be seen that the injected power of the other modules is reduced.

FIGS. 13(a)-13(c) show the ratios of steady-state current magnitudes over respective rated current for DC faults at each module, considering a range of V_{cm}/V_{7acm0} (selected V_{cm}/V_{7acm0}=1.2 for the 7-module DC hub shown in Table 1). It can be seen that fault current stays within 2 times the current under normal conditions, and that it is typically below 1.3 pu.

FIGS. 14(a)-14(h) show the system response to a DC fault. At 2.0 s, a permanent DC fault happens at module 6. At 2.05 s, module 6 is isolated by its circuit breaker CB₆. FIGS. 14(a)-14(g) show the AC current of each module. It can be seen that AC current for all the modules during the DC fault stays within 1.3 pu of its rated value. In FIGS. 14(a)-14(g), each current is a per-unit value taking the respective rated current of each module as the base value. FIG. 14(h) shows that no over-voltage will occur during faults. FIG. 14(h) also shows that, after the fault is cleared, the DC hub operates normally with 6 modules, and capacitor voltage is well controlled.

The circuit breakers CBᵢ employed by the present invention may be commonly available mechanical AC circuit breakers such as vacuum breakers, gas insulated breakers or any other type used with AC systems. The switches employed in the DC/AC converters may be any suitable switches, such as Insulated Gate Bipolar Transistors (IGBT).

Delta connection and star connection of capacitors Cᵢ are specifically described herein. However, it will be appreciated by those skilled in the art that capacitors Cᵢ may be connected together in any suitable way to give the required reactive power in balanced and symmetrical manner. All such connections can, however, be reduced to equivalent star connection giving the same reactive power.

### REFERENCES

[1] D. Van Hertem and M. Ghandhari, “Multi-terminal VSC HVDC for the European supergrid: Obstacles,” Renewable and Sustainable Energy Reviews, vol. 14, no. 9, pp. 3156-3163, 2010.
[2] JURGEN HÄFNER, BJÖRN JACOBSON “Proactive Hybrid HVDC Breakers—A key innovation for reliable HVDC grids”, CIGRE symposium, Bologna, September 2011.
[3] D Jovcic and B. T Ooi, “Developing DC transmission network using DC transformers” IEEE Transactions on Power Delivery, Vol. 25, issue 4, October 2010, pp 2535-2543.
[4] S. Loddick “Active Stator, a new generator Topology for direct drive permanent magnet generators” 9th IET International Conference on AC and DC Power Transmission, ACDC 2010; London October 2010.
[5] J Robinson, D Jovcic and G Joos, “Analysis and Design of an Offshore wind farm using MV DC grid” IEEE Transactions on Power Delivery, Vol. 25, issue 4, October 2010, pp 2164-2173.
[6] D. Jovcic, International patent application no PCT/GB2012/051486

1. (canceled)

2. A p-phase electronic hub for transferring power between N DC systems of DC voltage V_{idc} (i=1, 2, . . . N), respectively, the hub comprising:—
N modules, each for connection to a respective DC system of voltage V_{idc}, and for exchanging power Pᵢ with the respective DC system; and
a common p-phase AC bus for connecting the N modules;
wherein each module comprises:—
a DC/AC converter for transforming the respective DC voltage V_{idc} into a respective p-phase AC voltage V_{iac} of frequency ωₛ, root mean square line-neutral magnitude V_{iacm} and angle αᵢ, such that
V̅_̅{̅i̅a̅c̅}̅=V_{iacm} cos(αᵢ)+jV_{iacm} sin(αᵢ)=V_{iacd}+jV_{iacq}
where V̅_̅{̅i̅a̅c̅}̅ is the phasor of v_{iac}; and
an LC circuit for each phase p, for transferring power between the DC/AC converter of the module and the common p-phase AC bus, wherein each LC circuit comprises an inductor Lᵢ, a capacitor Cᵢ for supplying reactive power and a circuit breaker CBᵢ for disconnecting the module, connected together at their first terminals, the second terminal of each inductor Lᵢ being connected to the respective phase of the respective AC voltage V_{iac}, the second terminal of the circuit breaker CBᵢ being connected to the respective phase of the common AC bus, the second terminal of capacitor Cᵢ being connected to a central point of respective DC voltage V_{idc} in the case where p=1, and the second terminals of capacitors Cᵢ associated with each phase p being connected together in the case where p>1;
wherein, in use, the voltage of capacitor(s) Cᵢ is regulated at a value V_{cm}, where V_{cm}>V_{iacm} for all i;
wherein the value of each inductor Lᵢ is selected according to the formula:—
$${L}_{i} = \frac{{V}_{iacq} {V}_{cm}}{{P}_{im}}$$
and wherein the value of each capacitor Cᵢ is selected according to the formula:—
$${C}_{i} = \frac{{V}_{cm} - {V}_{iacd}}{{ω}_{s}^{2} {V}_{cm} {L}_{i}}$$
where V_{iacd} and V_{iacq} are any positive values that satisfy the inequality V_{iacd}²+V_{iacq}²≦V_{iacm0}², where V_{iacm0} is the maximum value of V_{iacm}.

3. A p-phase electronic hub as claimed in claim 2, wherein the voltage of capacitor(s) Cᵢ is regulated at a value V_{cm}, where V_{cm}>V_{iacm0} and where V_{iacm0} is the maximum value of V_{iacm} for all i;
wherein the value of each inductor Lᵢ is selected according to the formula:—
$${L}_{i} \leq \frac{{V}_{iacm 0} \sqrt{{V}_{cm}^{2} - {V}_{iacm 0}^{2}}}{{P}_{im} {ω}_{s}}$$
and wherein the value of each capacitor Cᵢ is selected according to the formula:—
$${C}_{i} \geq \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$
where V_{iacm0} is the maximum value of V_{iacm}.

4. A p-phase electronic hub as claimed in claim 2 wherein the voltage of capacitor(s) Cᵢ is regulated at a value V_{cm}, where V_{cm}>V_{iacm0} and where V_{iacm0} is the maximum value of V_{iacm} for all i;
wherein the value of each inductor Lᵢ is selected according to the formula:—
$${L}_{i} = \frac{{V}_{iacm 0} \sqrt{{V}_{cm}^{2} - {V}_{iacm 0}^{2}}}{{P}_{im} {ω}_{s}}$$
and wherein the value of each capacitor Cᵢ is selected according to the formula:—
$${C}_{i} = \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$
where V_{iacm0} is the maximum value of V_{iacm}.

5. A p-phase electronic hub as claimed in claim 2 wherein the power Pᵢₘ exchanged by each module with the respective DC system is controllable by varying V_{iacm} and αᵢ of the respective AC voltage V_{iac} generated by the DC/AC converter of the respective module.

6. A p-phase electronic hub as claimed in claim 2 wherein at least one of the N modules is configured for regulating the capacitor voltage V_{c} at value V_{cm}, whilst the other(s) of said N modules is/are configured for regulating the power exchanged by that module with the respective DC system.

7. A p-phase electronic hub for transferring power between N DC systems of DC voltage V_{idc} (i=1, 2, . . . N), respectively, the hub comprising:—
N modules, each for connection to a respective DC system of voltage V_{idc} and for exchanging power Pᵢ with the respective DC system; and
a common p-phase AC bus for connecting the N modules;
wherein each module comprises:—
a DC/AC converter for transforming the respective DC voltage V_{idc} into a respective p-phase AC voltage V_{iac} of frequency ωₛ, root mean square line-neutral magnitude V_{iacm} and angle αᵢ; and
an LC circuit for each phase p, for transferring power between the DC/AC converter of the module and the common p-phase AC bus, wherein each LC circuit comprises an inductor Lᵢ, a capacitor Cᵢ for supplying reactive power and a circuit breaker CBᵢ for disconnecting the module, connected together at their first terminals, the second terminal of each inductor Lᵢ being connected to the respective phase of the respective AC voltage V_{iac}, the second terminal of the circuit breaker CBᵢ being connected to the respective phase of the common AC bus, the second terminal of capacitor Cᵢ being connected to a central point of respective DC voltage V_{idc} in the case where p=1, and the second terminals of the capacitors Cᵢ associated with each phase p being connected together in the case where p>1.

8. A p-phase electronic hub as claimed in claim 7 wherein the voltage of capacitor(s) Cᵢ is regulated at a value V_{cm}, where V_{cm}>V_{iacm0} and where V_{iacm0} is the maximum value of V_{iacm} for all i;
wherein the value of each inductor Lᵢ is selected according to the formula:—
$${L}_{i} \leq \frac{{V}_{iacm 0} \sqrt{{V}_{cm}^{2} - {V}_{iacm 0}^{2}}}{{P}_{im} {ω}_{s}}$$
and wherein the value of each capacitor Cᵢ is selected according to the formula:—
$${C}_{i} \geq \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$
where V_{iacm0} is the maximum value of V_{iacm}.

9. A p-phase electronic hub as claimed in claim 7 wherein the voltage of capacitor(s) Cᵢ is regulated at a value V_{cm}, where V_{cm}>V_{iacm0} and where V_{iacm0} is the maximum value of V_{iacm} for all i;
wherein the value of each inductor Lᵢ is selected according to the formula:—
$${L}_{i} = \frac{{V}_{iacm 0} \sqrt{{V}_{cm}^{2} - {V}_{iacm 0}^{2}}}{{P}_{im} {ω}_{s}}$$
and wherein the value of each capacitor Cᵢ is selected according to the formula:—
$${C}_{i} = \frac{1}{{ω}_{s} {V}_{cm}^{2}} \frac{{P}_{im} \sqrt{{V}_{cm}^{2} - {V}_{iacm 0}^{2}}}{{V}_{iacm 0}}$$
where V_{iacm0} is the maximum value of V_{iacm}.

10. A p-phase electronic hub as claimed in claim 7 wherein the power Pᵢₘ exchanged by each module with the respective DC system is controllable by varying V_{iacm} and αᵢ of the respective AC voltage V_{iac} generated by the DC/AC converter of the respective module.

11. A p-phase electronic hub as claimed in claim 7 wherein at least one of the N modules is configured for regulating the capacitor voltage V_{c} at value V_{cm}, whilst the other(s) of said N modules is/are configured for regulating the power exchanged by that module with the respective DC system.
